(19) United States
(12) Patent Application Publication
(10) Pub. No.: US 2007/0058689 A1
(43) Pub. Date: Mar. 15, 2007

(54) Furnace panel

(75) Inventors: Nicholas M. Rymarchyk JR., Baden, PA (US); George Cingle III, Gibsonia, PA (US); Eric P. Tierney, Crescent, PA (US)

Correspondence Address: JOHN F. LETCHFORD, ARCHER & GREINER, P.C., ONE CENENNIAL SQUARE, HADDONFIELD, NJ, 08033, US

(73) Assignee: Nicholas M. Rymarchyk JR.

(21) Appl. No.: 11/226,490

(22) Filed: Sep. 13, 2005

(51) Int. Cl. F27D 1/12

(52) U.S. Cl. 373/76

(57) ABSTRACT

A water-cooled, bi-metal copper and steel furnace panel including one or more passageways for enabling gaseous and/or particulate matter to be discharged into a furnace vessel through the panel. The passageways may support metal treatment apparatus. The panel has a front plate made of copper and a rear plate made of steel. The front and rear plates are welded or otherwise joined to one another to define a water coolant passageway for cooling the front plate of the panel. An array of vanes is selectively securable to the inner face of the outer steel plate in any desired number and arrangement suitable to accommodate the gaseous/particulate matter discharge passageway(s) and the cooling requirements of the front plate.

### FIELD OF THE INVENTION

The present invention relates in general to furnace vessels and in particular to water-cooled wall panels for use in furnaces for making metals such as steel.

### BACKGROUND OF THE INVENTION

Water-cooled sidewall panels are commonly used in steelmaking furnaces to prevent thermal shock at hot spots that occur throughout the walls of the furnace vessel. This is particularly the case in electric arc furnaces (EAFs) where the furnace wall is subject to the extremely high heat loads created by the furnace electrodes. Typical panels are constructed as hollow box-like structures made of steel or copper through which water flows in order to cool the heat transfer face of the panel which is exposed to intense heat being generated in the furnace. Copper and steel have relative advantages and disadvantages when used as the principle material of a steelmaking furnace sidewall panel. Copper has better heat transfer properties than steel. That is, unlike cast copper panels, cast steel panels are subject to mechanical-thermal stresses due to uneven cooling across the face of the panel. However, copper is much more expensive than steel and does not have the structural strength of steel.

Water-cooled panels have also been used to provide mounting or support means for burners, injectors or other metal treatment means that discharge gaseous and/or particulate matter into the furnace during such procedures as scrap metal melting, slag formation, metal refining, post-combustion and the like. The panel can be an individually mounted unit or mounted as part of a module including other similarly constructed furnace panels.

Typically, a water-cooled wall panel for a metal making furnace is made from a highly conductive material such as cast copper for optimum heat transfer. Thus, not only are the front face and sides of the panel made of copper but so too is the panel back face, i.e., the face of the panel designed to face outwardly from the furnace. However, heat transfer through the panel back face is not a panel design parameter. Thus, the very provision of a panel back face made of copper adds needless expense to the typical water-cooled furnace sidewall panel.

In order to properly cool the panel during use, an intricate water baffle design must be cast internally of the panel at the time of its formation. The internal water-cooled area must be integrally cored and cast to assure proper water flow distribution configuration and metal thickness. In addition, panel mounting lugs, water inlet and outlet connections and burner/injector mounting bosses must also be formed into the back face of the poured panel. The panel is also produced such that during foundry teeming, the hot face is chilled to develop smaller grain size and promote directional solidification. However, the shrinkage associated with cooling of the panel front face requires the provision of several casting gates and risers to accommodate the additional molten metal needed to compensate for the reduced volume of the cooled front face.

In addition to the foregoing, many other problems are inherent in integrally cast water-cooled furnace panels. Included among these are:

1. Difficulty in maintaining a uniform internal water passage core arrangement.

2. Uneven panel back face metal thicknesses resulting in shrinkage defects.

3. A large internal core area that causes off-gassing during casting and results in porosity defects.

4. No direct methods to visually inspect the casting's interior or clean the critical internal water passages.

5. Weld repair of casting defects requires preheating which creates a high probability of post-weld crack propagation in the casting.

6. Mounting lug damage or misalignment repairs require preheating with specialized welding techniques which also creates a high probability of post-weld crack propagation in the casting.

7. With a copper panel casting, the panel back face is more susceptible to mechanical damage during installation of the burners, injectors and connections (e.g., cross-threading, impact damage) which may require panel replacement or specialized weld repairing to ameliorate the harm.

8. The cooling water distribution typically differs for each metal manufacturer/customer, thereby necessitating a unique panel casting for each manufacturer and the maintenance of a large inventory and work-in-process castings to fulfill customer needs.

U.S. Pat. Nos. 6,137,823; 4,304,396 and 4,216,348 disclose the use of bi-metal steel and copper water-cooled panels for use in EAF vessel sidewall and/or roof panels. The front or “hot” face of the panels, i.e., the panel face designed to face the interior of the furnace, is made of copper and the back face is made of steel. The front and rear faces are welded or otherwise joined to one another to define a water coolant passageway for cooling the front face of the panel. The resultant panels are comparable in thermal efficiency to panels cast entirely of copper yet are less expensive to manufacture and maintain. However, none of the bi-metal panels disclosed in these patents contemplates the use of copper and steel in a bi-metal panel having passageways through which gaseous and/or particulate matter is discharged through the panel into a furnace vessel. Indeed, U.S. Pat. No. 4,304,396 discloses water-cooled, bi-metal copper and steel furnace sidewall panels as being separate and distinct from burner support panels that are also provided in the furnace wall.

An advantage exists, therefore, for a water-cooled, bi-metal copper and steel furnace sidewall panel including at least one passageway for enabling gaseous and/or particulate matter to be discharged into a furnace vessel through the panel.

### SUMMARY OF THE INVENTION

The present invention is directed to a water-cooled, bi-metal copper and steel furnace panel including passageway means for enabling at least one of gaseous and particulate matter to be discharged into a furnace vessel through the panel. In a preferred embodiment, the passageway means may include support means for metal treatment apparatus. The front plate or “hot” face of the panel is made of copper and the rear plate or rear face is made of steel. The front and rear plates are welded or otherwise joined to one another to define a water coolant passageway for cooling the front plate of the panel. In a preferred embodiment, the panel is a two-piece unit comprising a steel back plate welded to a copper shell including the front plate and integral copper panel sides. An array of vane means is selectively securable to the inner face of the outer steel plate in any desired number and arrangement suitable to accommodate the gaseous/particulate matter discharge passageway(s) and the cooling requirements of the front plate. The present invention thus contemplates a versatile, thermally efficient yet cost-effective water-cooled furnace wall panel for enabling gaseous and/or particulate matter to be injected into a metal making furnace vessel through the panel.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is an elevational view of a portion of an electric arc furnace;

FIG. 2 is a rear view of a furnace panel constructed according to the present invention;

FIG. 3 is a side elevation view of the furnace panel of FIG. 2;

FIG. 4 is a front view of the furnace panel of FIG. 2;

FIG. 5 is cross-section view of a furnace panel constructed according to the present invention taken along line V-V of FIG. 4;

FIG. 6 is cross-section view of a furnace panel constructed according to the present invention taken along line VI-VI of FIG. 4;

FIG. 7 is cross-section view of a furnace panel constructed according to the present invention taken along line VII-VII of FIG. 3;

FIG. 8 is enlarged view of Detail VIII of FIG. 3;

FIG. 9 is cross-section view taken along line IX-IX of FIG. 8; and

FIG. 10 is a rear view of furnace wall module incorporating a furnace panel constructed according to the present invention and additional an additional panel for mounting other metal treatment apparatus.

### DETAILED DESCRIPTION OF THE INVENTION

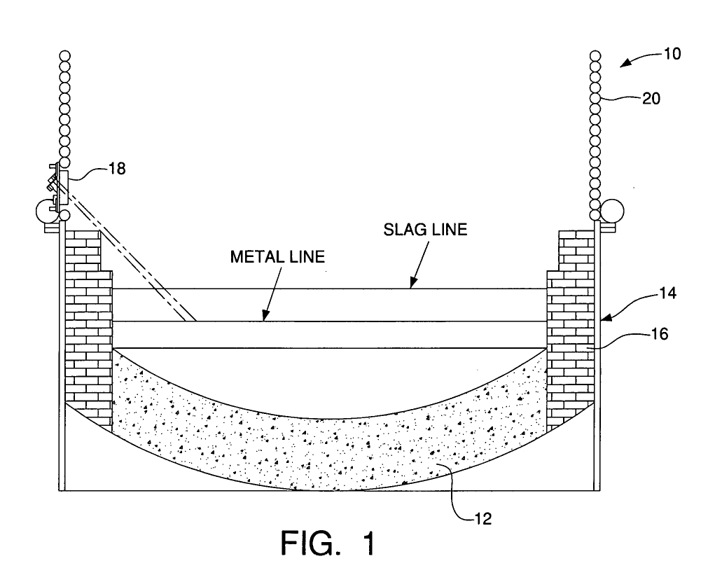

Referring to the drawings wherein like or similar references indicate like or similar elements throughout the several views, there is shown in FIG. 1 a portion of a typical electric arc furnace (EAF) generally designated by reference numeral 10. The furnace has a bottom wall 12, and a side wall 14. The top wall or roof as well as the furnace electrodes are not relevant to the present invention and are omitted for clarity of illustration. The side wall 14 of the furnace 10 includes a lower section formed of refractory brick 16, a middle section of conventional water-cooled steel or cast copper panels 18 (which may, as illustrated, support metal treatment apparatus such as those described herein), and an upper section of water-cooled pipe coils 20.

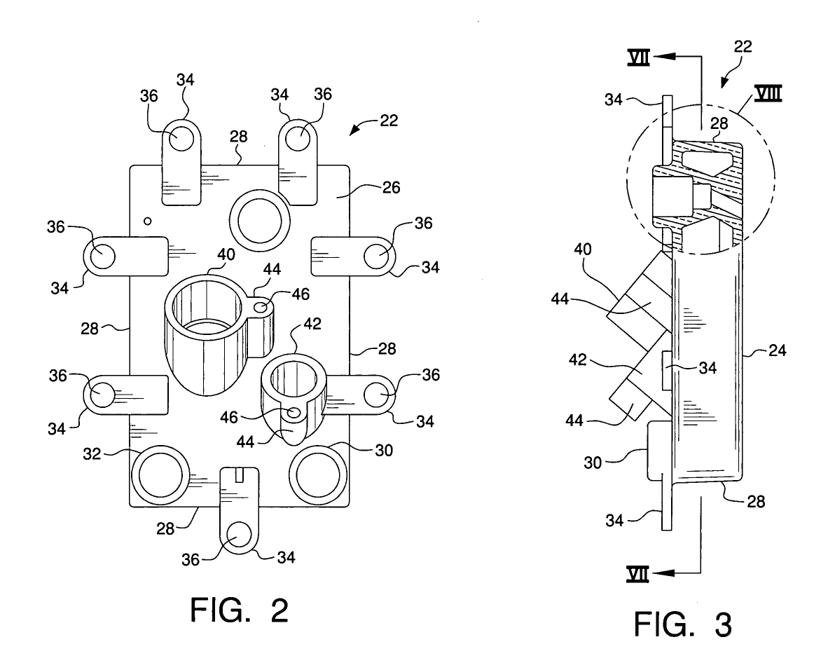

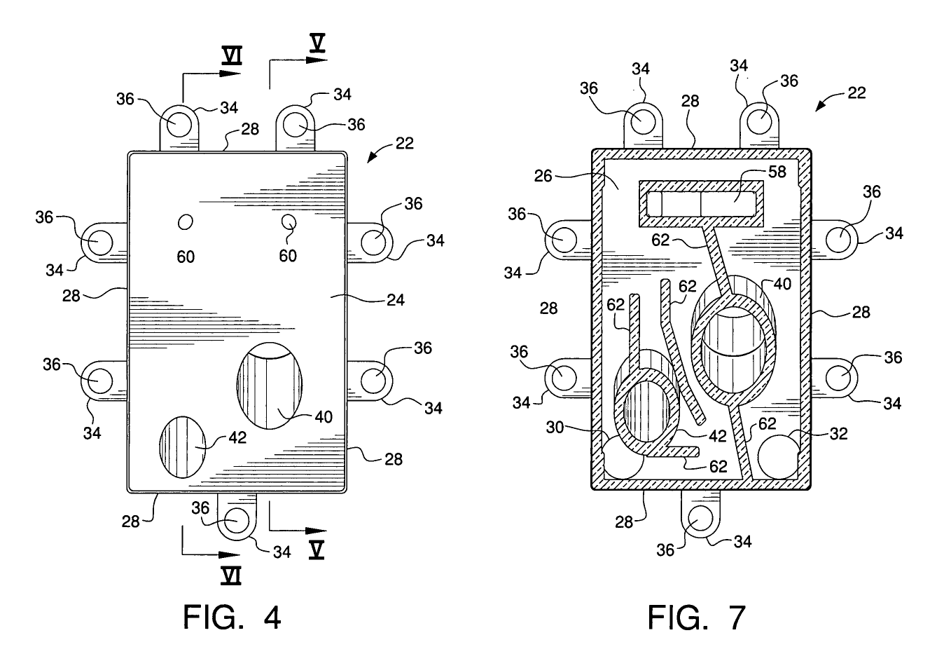

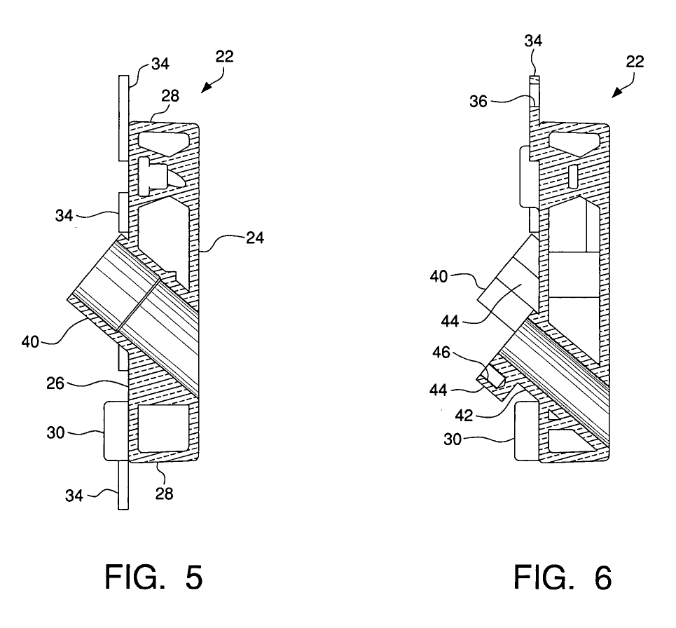

Turning to FIGS. 2-9, there is shown a furnace panel constructed in accordance with the present invention, generally designated by reference numeral 22, which may be used in an EAF such as that depicted in FIG. 1 or any other high-temperature metal making furnace in which water-cooled panels having gaseous and/or particulate matter flow passageways may be beneficially employed. Referring initially to FIGS. 2-4, it will be seen that panel 22 comprises a front plate or “hot” face 24 and a rear plate or rear face 26. Front plate 24 is directed toward the interior of a furnace and rear plate 26 is directed away from the interior of a furnace when panel 22 is installed in a furnace side wall. According to the invention, panel 22 is a bi-metal assembly in which the front plate 24 is made of copper, preferably cast copper, and the rear plate 26 is made of steel. The front and rear plates are welded or otherwise joined to one another to define a coolant water flow passageway, described below, for cooling the front plate 24 during furnace operation. In a preferred embodiment, the front plate or hot face 24 is part of an integrally cast three-dimensional copper shell including panel sidewalls 28 wherein the steel rear plate 26 is welded or otherwise firmly yet removably attached to the panel sidewalls 28.

Rear plate 26 preferably includes a water inlet 30 and a water outlet 32 for enabling coolant water flow through the panel. Plate 26 also has means for mounting panel 22 to the wall of the furnace. Preferably, the mounting means comprises a plurality of steel lugs 34 welded or otherwise secured to the rear face of the plate. Lugs 34 include apertures 36 which receive pins provided in the furnace wall such as pins 38 (FIG. 10) to permit ready installation and removal of panel 22 from the furnace wall.

According to the present invention, panel 22 includes passageway means for enabling at least one of gaseous and particulate matter to be discharged into a furnace vessel through the panel. Pursuant to a presently preferred embodiment, the passageway means may comprise at least one means for supporting or mounting apparatus for treating metal. Such metal treating apparatus may include any device or mechanism for discharging gaseous and/or particulate matter into a furnace vessel during such procedures as scrap metal melting, slag formation, metal refining, post-combustion and the like. Examples include, without limitation, burners, oxygen and/or other gas stream injection devices, and devices for injecting particulate matter entrained in a flow of pressurized gas. In the illustrated example, panel 22 includes a pair of tubes 40 and 42, the inlets and outlets and general configurations of which are variously shown in FIGS. 2-7. By way of example, tube 40 may be sized to accommodate a conventional burner and/or gas injection device such as burner 50 shown in FIG. 10 and tube 42 may be sized to accommodate a conventional particulate matter injection device such as particulate injector 52, also shown in FIG. 10. As depicted throughout FIGS. 2-7, tubes 40 and 42 are preferably disposed at a downwardly directed acute angle (preferably about 30° to about 60°) with respect to the inner and outer plates 24 and 26. In order to releasably yet firmly secure the burner 50 and particulate injector 52 to tubes 40 and 42, each of the tubes is preferably provided with a lobe 44 at its inlet end which includes a threaded bore 46. The threaded bores 46 are adapted to receive threaded fasteners 48 that may be selectively tightened against flanges carried by the burner 50 and particulate injector 52 in the manner shown in FIG. 10.

According to a preferred embodiment, tubes 40 and 42 are integrally cast with the copper shell including front plate 24 and side walls 28. Depending on their desired lengths, diameters and wall thicknesses, tubes 40 and 42 may be initially cast as tubular members or they may be cast as solid members that are thereafter bored to produce the desired tubular configurations.

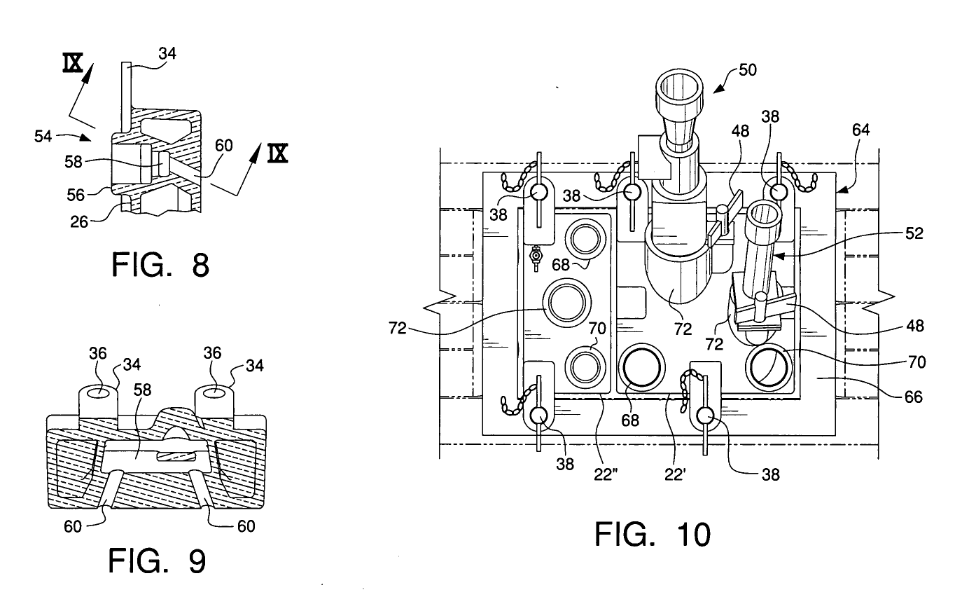

As seen most clearly in FIGS. 8 and 9, panel 22 may optionally include additional passageway means for enabling matter to be discharged into a furnace vessel through the panel. That is, panel 22 may include means for introducing gaseous matter such as, for example, oxygen or other gas, into a furnace vessel. By way of illustration but not limitation, it will be assumed that panel 22 is to be used in a side wall of a steelmaking furnace vessel. In that event, the additional injection means, identified generally by reference numeral 54 in FIG. 8, may include means for introducing post-combustion oxygen gas to assist in combustion of CO to CO₂ to enhance the heat transfer efficiency of the steelmaking process. Toward that end, the panel 22 may be provided with an oxygen inlet 56 to which an unillustrated source of oxygen gas may be connected. Inlet 56 is in fluid communication with an internal plenum 58 which, in turn, delivers oxygen to one or more discharge outlets 60. Inlet 56, plenum 58 and outlet(s) 60 may be cast integrally with the front plate 24 or one or more of these components may be carried by the back plate 26.

Referring to FIG. 7, it will be seen that the interior of panel 22 is provided with vane means 62 for directing water to flow in a circuitous path through the panel from water inlet 30 to water outlet 32 in order to cool the panel hot face. At least one (and preferably most, if not all) of vane means 62 is a steel member welded to the inner surface of the rear steel plate 26. Because different metal making furnaces have different gaseous/particulate matter injection and wall panel cooling requirements, vane means 62 may be included in any number and arranged in virtually any configuration to achieve the desired results. That is, one or more vane means 62 may be secured to the inner face of rear plate 26 and arranged as needed to accommodate the gaseous and/or particulate matter passageway means to define a circuitous water coolant path for cooling the front plate 24. In this way, the design and pouring of the cast copper shell is simplified, more comparatively less expensive steel is used in the panel, and the copper shell is adaptable to a broad assortment of furnace wall installations.

Panel 22 has thus far been described as a discrete and independent panel that is useful by itself in the wall of a metal making furnace. However, panel 22 or a similar panel may be but one of a plurality of similarly constructed water-cooled panels that may be component parts of a larger modular unit 64 that may be installed in a furnace wall. More specifically, as shown in FIG. 10, a panel 22′ generally similar in construction and operation to panel 22 may constitute a first panel component of modular unit 64 and additional similarly constructed water-cooled panel(s) such as panel 22″ may also be deployed in modular unit 64. Both of panels 22′ and 22″ are mounted within a frame 66 of modular unit 64 which itself is mountable in a furnace wall. By way of example, panels 22′ and 22″ may have a water inlet 68 and a water outlet 70 as well as one or more passageways 72 for enabling discharge of matter into a furnace vessel. It will be appreciated that panels 22′ and 22″ operate independently of one another and one may continue operation while the other is being serviced. Additionally, one or both of the panels 22′ and 22″ may be conveniently serviced by removing their steel back plates without having to remove the modular unit 64 from the furnace wall.

Included among the advantages realized by the furnace panel of the present invention are:

1. The copper hot face shell becomes a simple casting requiring no internal cores and is easily inspected for metal thickness consistency.

2. The back plate is a less expensive yet comparatively thick steel plate that is attached to the hot face casting by welding, thereby eliminating inherent casting defects.

3. The steel back plate can be easily modified with any variety of attachment lugs and mounting frames to readily accommodate any furnace configuration.

4. Damage to the back plate or the internal vanes can be repaired by conventional welding procedures without removing the panel from the furnace.

5. The modular design of the panel minimizes inventory requirements by standardizing only two items—the hot face copper shell casting and the steel back plate.

6. A single copper face casting can accommodate many different water inlet, outlet and flow path variations since the water connections and internal flow vanes are welded to the steel back plate in any desired arrangement as opposed to being cast into the copper panel as is presently done in conventional unitary cast panels.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A furnace panel comprising:
an inner copper plate;
an outer steel plate;
the inner and outer plates being joined together to form a hollow bi-metal panel through which water is flowable; and
passageway means for enabling at least one of gaseous and particulate matter to be discharged into a furnace vessel through the panel.

2. The furnace panel of claim 1 further comprising means carried by said outer steel plate for mounting the panel to a furnace vessel.

3. The furnace panel of claim 2 wherein said means for mounting the panel to a furnace vessel comprise a plurality of lugs.

4. The furnace panel of claim 1 wherein said passageway means comprise at least one means for supporting metal treatment apparatus operable to discharge at least one of gaseous and particulate matter into a furnace vessel

5. The furnace panel of claim 4 wherein said means for supporting metal treatment apparatus is cast integrally with said inner copper plate.

6. The furnace panel of claim 4 wherein said means for supporting metal treatment apparatus comprise at least one tube having a front end terminating at said inner copper plate and a rear end projecting from said outer steel plate.

7. The furnace panel of claim 6 wherein said at least one tube is disposed at an acute angle with respect to said inner and outer plates.

8. The furnace panel of claim 1 further comprising a water inlet and a water outlet carried by said outer steel plate.

9. The furnace panel of claim 1 further comprising vane means for directing water to flow in a circuitous path through said panel, said vane means being carried by an inner face of said outer steel plate and arranged to accommodate said passageway means.

10. The furnace panel of claim 1 wherein further comprising side walls cast integrally with said inner copper plate.

11. The furnace panel of claim 10 wherein said outer steel panel is connected to said side walls.

12. A modular furnace panel unit comprising:
a plurality of furnace panels, each of said panels comprising:
an inner copper plate;
an outer steel plate;
the inner and outer plates being joined together to form a hollow bi-metal panel through which water is flowable; and
passageway means for enabling at least one of gaseous and particulate matter to be discharged into a furnace vessel through the panel; and
a frame within which said panels are mounted, said frame being mountable in a furnace wall.
